(19) United States
(12) Patent Application Publication
(10) Pub. No.: US 2026/0134468 A1
(43) Pub. Date: May 14, 2026

(54) SYSTEMS AND METHODS FOR PREDICTING USER PLANS FOR FUTURE UNITS

(71) Applicant: Hungryroot, Inc., New York, NY (US)

(72) Inventors: Antoine Atallah, Bellevue, WA (US); Xiaowei Bao, Portland, OR (US); Jasmine Feng, Renton, WA (US); Jingchen Cao, Dublin, CA (US); Benjamin Pierce McKean, Mooresville, NC (US)

(21) Appl. No.: 18/946,597

(22) Filed: Nov. 13, 2024

(51) Int. Cl. G06Q 30/0601

(52) U.S. Cl. CPC G06Q 30/0635

(57) ABSTRACT

Systems and methods to optimize a user plan while predicting and selecting units for a user. A user plan is received for a user to be provided a plurality of units at a given frequency. A type of each unit of the plurality of units is determined based on the user plan. The plurality of units are selected for the user in accordance with the determined type of each unit. User input that changes the type of at least one unit of the selected plurality of units is received. The user plan is then optimized based on the user input.

### TECHNICAL FIELD

The present disclosure relates generally to unit selection and distribution systems and, more particularly, to optimizing a user plan for units based on user-provided changes to selected units.

### BACKGROUND

### Description of the Related Art

The use of ordering food and grocery, and other products, online has gained in popularity over the past few years. Many of these online services allow users to select which items they wish to purchase using an online computer interface. After the user selects and pays for their items, a “runner” collects the items from the shelves such that the user can simply pick up their order and take it home. Some systems also allow for the items to be sent directly to the user's home. These systems, however, generally require the user to know which items they wish to purchase. Some newer systems have added the option of a user selecting groups of items, such as a particular recipe. The specific items and their portions for that particular group are then sent to the user. Upon arrival, the user can prepare the unit, e.g., recipe, using the items provided. Unfortunately, many of these online item-purchasing systems are limited by the user's preferences and provide little flexibility in understanding how a user's preferences may change over time. It is with respect to these and other considerations that the embodiments described herein have been made.

### BRIEF SUMMARY

Briefly described, embodiments are directed toward systems and methods of optimizing a user plan while predicting and selecting units for a user. A user plan is received for a user to be provided a plurality of units at a given frequency. A type of each unit of the plurality of units is determined based on the user plan. The plurality of units are selected for the user in accordance with the determined type of each unit. User input that changes the type of at least one unit of the selected plurality of units is received. The selected units are then updated based on the user changes and an order for the plurality of units is initiated. The user plan is also optimized based on the user input, such as by modifying the user plan to include the changed type of the at least one unit or selecting a different user plan that includes at least the number of units of each type as changed by the user.

Embodiments described herein can improve the operation of the item delivery computing systems, reduce errors in item deliveries, improve user or customer satisfaction, reduce the amount of item waste in users' homes and at the fulfillment warehouse, and even improve the operation of the various computing components of the system. For example, by specifically optimizing the user plan, as described herein, fewer computing resources are then utilized to predict a next group of units to provide to a user because the system does not have to waste computing resources receiving additional user changes and updating the selected units based on those changes. Moreover, the automatic fulfillment of an order with the selected units includes the command or control of other computing systems, which again improves the operation of item delivery computing systems.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings.

FIG. 1 illustrates a context diagram of an environment for predicting and optimizing a user plan based on previously provided user changes in accordance with embodiments described herein.

FIG. 2 illustrates a logical flow diagram showing one embodiment of a process for predicting and optimizing a user plan based on previously provided user changes in accordance with embodiments described herein.

FIG. 3 illustrates a use case example of a user plan and an optimized user plan in accordance with embodiments described herein.

FIG. 4 shows a system diagram that describes various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

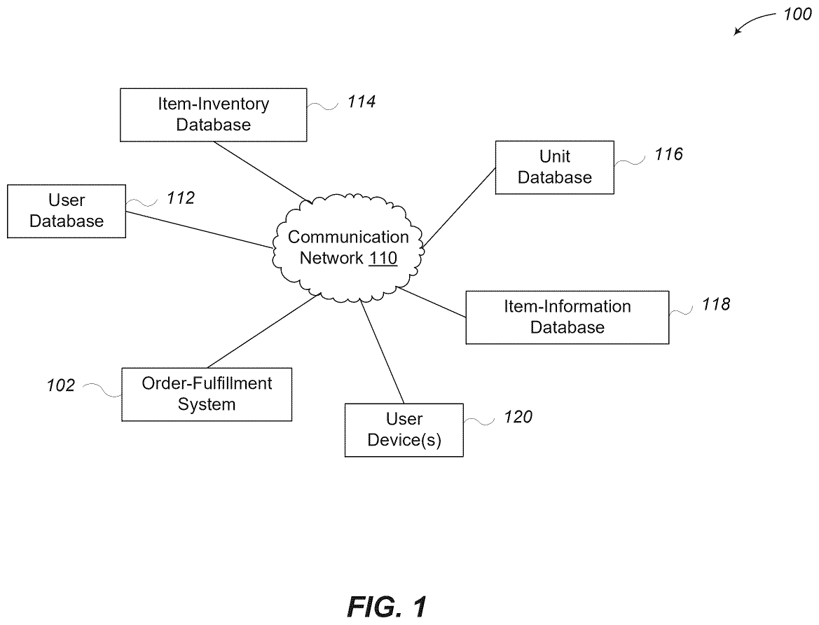

FIG. 1 illustrates a context diagram of an environment for predicting and optimizing a user plan based on previously provided user changes in accordance with embodiments described herein. In this example, environment 100 includes an order-fulfillment system 102, a customer database 112, an item-inventory database 114, a unit database 116, an item-information database 118, and a user devices 120. These computing devices and systems can communicate with one another via communication network 110. Communication network 110 includes one or more wired or wireless networks in which data or communication messages are transmitted between various computing devices.

The order-fulfillment system 102 is a computing device or system that dynamically selects a group of units for a user based on a user plan and dynamically generates an optimized user plan based on changes made by the user to selected units. The user plan defines the frequency in which the user is to be provided units and the types of units to provide. As described herein, a user may change the number of different types of units when a group of units are to be provided to the user as part of an order. The order-fulfillment system 102 tracks those changes over time; and when a threshold number of changes are made by the user, the order-fulfillment system 102 automatically optimizes the user plan based on those changes. In this way, the order-fulfillment system 102 can use the optimized user plan for future orders for the user. A group of units may include one or more units, such as recipes, outfits, health care packages, or other goods or products that can be sent or delivered to users. Moreover, each unit may include one or more items. Items are objects provided with the units for the users to implement the unit. In the example where a group of units include recipes, items may include the various ingredients, food products, cooking utensils, measurement tools, or other non-food objects needed to make the recipes. In the example where units include outfits, the items may include clothes, shoes, jewelry, bags, or other wearable accessories that make up an outfit.

The user devices 120 are computing devices that can communicate with the order-fulfillment system 102 to request orders of groups of units, change or modify unit types for an order, select units or items, provide user/customer preferences, etc. Examples of user devices 120 may include personal computers, laptop computers, smartphones, tablet computers, etc.

The user database 112 is a computing device that is configured to store user/customer information for a plurality of users. The customer information may include, but is not limited to, user preferences, histories of groups of units previously provided to users (i.e., user order history), user customization history, lists of items previously provided to the user, current user inventory (e.g., items or ingredients already owned by the user), etc. The user database 112 is further configured to communicate with the order-fulfillment system 102 via the communication network 110 to provide various customer information to the order-fulfillment system 102 to enable the order-fulfillment system 102 to generate or employ an artificial intelligence model based on sequences of groups of units, as described herein.

The unit database 116 is a computing device that is configured to store a plurality of units. The unit database 116 is configured to communicate with the order-fulfillment system 102 via the communication network 110 to provide lists of units and their items to the order-fulfillment system 102 for the order-fulfillment system 102 to predict, optimize, and select groups of units for users, as described herein.

The item-inventory database 114 is a computing device configured to store inventory information regarding a plurality of items that are associated with at least one unit stored by the unit database 116 and can be delivered to a user. The item-inventory database 114 is further configured to communicate with the order-fulfillment system 102 via the communication network 110 to provide item-inventory information to the order-fulfillment system 102 for the order-fulfillment system 102 to predict, optimize, and select groups of units for users, as described herein.

The item-information database 118 is a computing device that is configured to store information regarding the plurality of items that are associated with at least one unit stored by the unit database 116. In the example where units include recipes, this item information may include, but is not limited to, dietary information, specific ingredients, cost or price, volume metrics, etc. In the example where units include outfits, this item information may include, sizes, colors, seasons, etc. The item-information database 118 is further configured to communicate with the order-fulfillment system 102 via the communication network 110 to provide item information to the order-fulfillment system 102 for the order-fulfillment system 102 to optimize or select groups of units for users, as described herein.

Although the order-fulfillment system 102, the user database 112, the item-inventory database 114, the unit database 116, and the item-information database 118 are illustrated as separate computing devices or systems, embodiments are not so limited. Rather one or more computing devices or systems may be utilized to perform the functionality of the order-fulfillment system 102, the user database 112, the item-inventory database 114, the unit database 116, and the item-information database 118. Accordingly, in some embodiments, the order-fulfillment system 102 may store or manage the user database 112, the item-inventory database 114, the unit database 116, or the item-information database 118, or some combination thereof. Similarly, the functionality of the order fulfillment system 102 may be employed by a single computing system or a plurality of computing systems.

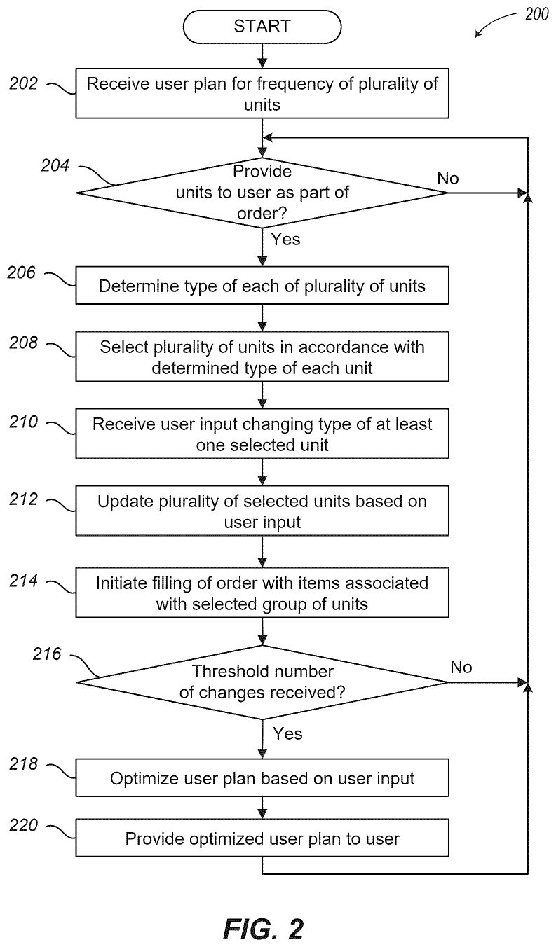

FIG. 2 illustrates a logical flow diagram showing one embodiment of a process 200 for predicting and optimizing a user plan based on previously provided user changes in accordance with embodiments described herein. Process 200 may be implemented by one or more processors or executed via circuitry on one or more computing devices, such as order-fulfillment system 102 in FIG. 1.

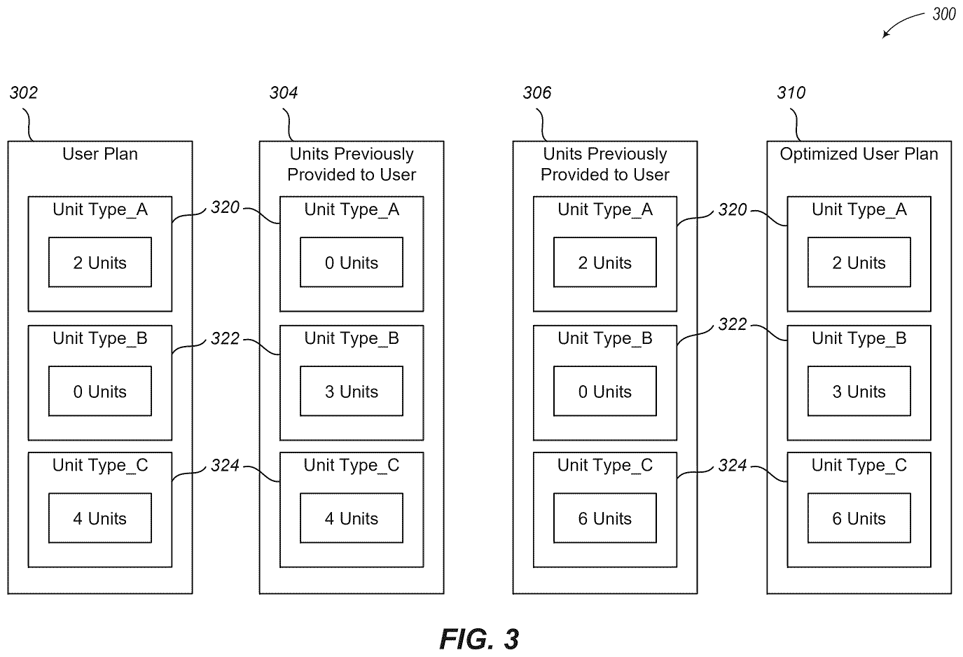

Process 200 begins, after a start block, at block 202, where a user plan is received. The user plan indicates the frequency, or how often, the user is provided with a group of a plurality of units. The frequency may be once a week, every other week, or some other interval in which units can be provided to the user. The user plan also indicates how many units of each of a plurality of unit types to provide to the user for each separate frequency interval. As one illustrative example in FIG. 3, the user plan may indicate that the user is to be provided two units of unit_type_A, zero units of unit_type_B, and four units of unit_type_C. If the units are recipes, then unit_type_A may represent breakfast recipes, unit_type_B may represent lunch recipes, and unit_type_C may represent dinner recipes. In the illustrative example in FIG. 3, the user may be provided two breakfast recipes, four dinner recipes, and no lunch recipes.

Process 200 proceeds, after block 202, to decision block 204, where a determination is made whether to provide units to the user based on the user plan. In some embodiments, this occurrence may be referred to as receiving an order for a group of units. In various embodiments, this determination occurs when the interval frequency of the user plan occurs. If units are to be provided to the user, then process 200 flows to block 206; otherwise, process 200 loops to decision block 204 to wait until units are to be provided to the user based on the user plan.

At block 206, a type of each of a plurality of units is determined based on the plan. As noted herein, the user plan indicates how many units of each of a plurality of unit types to provide to the user.

Process 200 continues, after block 206, at block 208, where the plurality of units are selected for the user in accordance with the determined type of each unit. In various embodiments, the plurality of units are selected from a database of possible units based on preferences of the user or other prediction/selection techniques for the user so long as the selected units meet the determined type of each unit determined in block 206 from the user plan. Using the recipe example above and illustrated in FIG. 3, two breakfast recipes and four dinner recipes are selected for the user, but no lunch recipes.

Various selection mechanisms may be employed to select the specific units of the determined unit type for the user. As one example, a sequence of groups of units previously provided to the user may be determined. A trained artificial intelligence model may be employed to predict one or more next groups of units (also referred to as recommending future groups of units) based on the sequence of groups of units previous provided to the user, such as described in U.S. patent application Ser. No. 18/931,825 filed on Oct. 30, 2024, which is incorporated herein in its entirety. From these is predicted next groups of units, a group of units is selected or optimized for the user's order so long as the selected units meet the determined type of each unit.

Various information regarding the units and items for each unit may also be utilized to select the specific group of units from the predicted next group of units. For example, the unit database 116 may be accessed to identify a list of items for each predicted unit, the item-information database 118 may be accessed to obtain additional item information for that list of items, and the item-inventory database 114 may be accessed to obtain inventory management information for that list of items. The system can utilize the predicted groups of units, the additional item information, and the inventory information to select the group of units for the target user. In various other embodiments, the system can also utilize user information (e.g., as obtained from user database 112) to select the group of units for the target user, which allows the system to not only select a group of units that the target user may like, but also to select a group of units that utilizes items already owned by the target user. In some embodiments, hard constraints or soft constraints for the user can be utilized to select the group of units. The soft constraints may define at least one parameter that expresses a tradeoff value associated with a unit or group of units for the target user. For example, the target user may prefer one type of unit (e.g., chicken recipes) over another type of unit (e.g., turkey recipes). The hard constraints may define at least one parameter that cannot be violated by a unit or group of units for the user. For example, the user cannot have any units that have a particular item (e.g., the target user is allergic to soy).

Process 200 proceeds, after block 208, to block 210, where user input that changes the type of at least one selected unit is received. For example, the user may be provided with a graphical user interface showing the selected units. From this graphical user interface, the user may change a selected unit from unit_type_A to unit_type_B. In some embodiments, the user may request additional units of a particular unit type. For example, the user may request six units of unit_type_C, even though the user plan is for four units of unit_type_C. Examples of these unit type changes are illustrated in FIG. 3.

Process 200 continues, after block 210, at block 212, where the plurality of selected units are update based on the user input. In various embodiments, the group of units are re-selected using embodiments of block 208, but with the user-changed type of at least one unit, or the user-changed number of units for a given type of units.

Process 200 proceeds, after block 212, to block 214, where filing of the order is initiated with items associated with the updated group of units selected for the user. In some embodiments, initiating the filing of the order may include sending commands or instructions to another computing system to automatically collect for shipping or automatically ship the items associated with the selected group of units to the user. In other embodiments, initiating the filing of the order may include sending commands or instructions to another computing system to automatically print or send a copy of the selected group of units to the user.

Process 200 continues, after block 214, at decision block 216, where a determination is made whether a threshold number of user changes have been received. The threshold number of user changes may be defined by an administrator. For example, the threshold number of user changes may be changing a selected unit from unit_type_A to unit_type_B four times within a two-month period. As another example, the threshold number of user changes may be changing from four units of unit_type_C to six units of unit_type_C two times within a one-month period. These examples are not to be limiting, but are for illustrative purposes only. If the threshold number of user changes have been received, then process 200 flows to block 218; otherwise, process 200 loops to decision block 204 to wait until a next group of units are to be provided to the user based on the user plan.

At block 218, the user plan is optimized based on the user input. In various embodiments, the user plan is optimized by modifying the user plan to include the maximum number of units for each type over a select period of time. In other embodiments, the user plan is optimized by selecting a different user plan that is predefined to include a number of units for each unit type that is equal to or greater than the number of units selected or changed by the user. For example, the user may change from four units of unit_type_C to five units of unit_type_C, but a next largest user plan is for six units of unit_type_C.

Process 200 proceeds, after block 218, to block 220, where the optimized user plan is provided to the user. In some embodiments, the optimized user plan is automatically implemented as the current user plan for the user. In other embodiments, a graphical user interface showing the optimized user plan is presented to the user, which gives the user the option of declining/rejecting or accepting the optimized user plan. If the user declines the optimized user plan, then the optimized user plan is discarded (or ignored or disregarded) and the original user plan is maintained for the user as the current user plan. But if the user accepts the optimized user plan, then the optimized user plan is activated for the user as the current user plan and the original user plan is discarded or ignored.

After block 220, process 200 loops to block 204 to wait until a next group of units are to be provided to the user based on the current user plan (whether the optimized user plan or the original user plan).

FIG. 3 illustrates a use case example 300 of a user plan and an optimized user plan in accordance with embodiments described herein. Example 200 includes user plan 302, user changes 304 and 306, and optimized user plan 310. In this example, user plan 302 includes two units of unit_type_A (320), zero units of unit_type_B (322), and four units of unit_type_C (324).

During a first order, the user changed to zero units of unit_type_A (320), three units of unit_type_B (322), and maintained four units of unit_type_C (324), as shown in user changes 304. After these changes, units of those unit types were selected and provided to the user.

During a second order, the user maintained two units of unit_type_A (320), and maintained zero units of unit_type_B (322), but changed to six units of unit_type_C (324), as shown in user changes 306. After these changes, units of those unit types were selected and provided to the user.

By employing embodiments described herein, optimized user plan 310 may be generated for the user in response to a threshold number of changes being made by the user. In this illustrative example, the optimized user plan 210 includes two units of unit_type_A (320), and three units of unit_type_B (322), and six units of unit_type_C (324)—the maximum number of units for each type previously changed by the user.

As discussed herein, the optimized user plan may be selected from previously defined user plans. Although not shown, user plans may provide only odd numbers of units of each type. In this situation, the optimized user may may include two units of unit_type_A (320), four units of unit_type_B (322), and six units of unit_type_C (324). In this way, the optimized user plan includes a number of units of each unit type equal to or greater than the numbers of units selected or changed by the user.

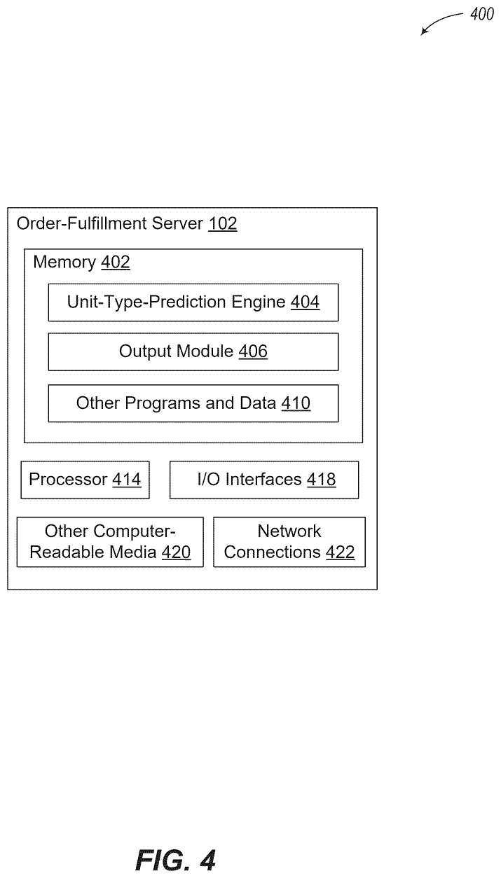

FIG. 4 shows a system diagram that describes various implementations of computing systems for implementing embodiments described herein. System 400 includes an order-fulfillment system 102, similar to what is described in FIG. 1. System 400 may also include a user database 112, an item-inventory database 114, a unit database 116, an item-information database 118, and user devices 120 similar to what is illustrated in FIG. 1; but those databases, systems, and devices are not illustrated in FIG. 4 for ease of discussion.

The order-fulfillment system 102 dynamically optimizes a user plan for a user based on changes the user makes to unit types when an order for units is being fulfilled for the user, as described herein. One or more special-purpose computing systems may be used to implement the order-fulfillment system 102. Accordingly, various embodiments described herein may be implemented in software, hardware, firmware, or in some combination thereof. The order-fulfillment system 102 may include memory 402, processor 414, I/O interfaces 418, other computer-readable media 420, and network connections 422.

Processor 414 includes one or more processors, one or more processing units, programmable logic, circuitry, or one or more other computing components that are configured to perform embodiments described herein or to execute computer instructions to perform embodiments described herein. In some embodiments, a processor system may include a single processor 414 that operates individually to perform actions. In other embodiments, a processor system may include a plurality of processors 414 that operate to collectively perform actions, such that one or more processors 414 may operate to perform some, but not all, of such actions. Reference herein to “a processor system” refers to one or more processors 414 that individually or collectively perform actions. And reference herein to “the processor system” refers to 1) a subset or all of the one or more processors 414 comprised by “a processor system” and 2) any combination of the one or more processors 414 comprised by “a processor system” and one or more other processors 414.

Memory 402 may include one or more various types of non-volatile and/or volatile storage technologies. Examples of memory 402 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 402 may be utilized to store information, including computer-readable instructions that are utilized by processor 414 to perform actions, including embodiments described herein.

Memory 402 may have stored thereon unit-type-prediction engine 404 and output module 406. The unit-type-prediction engine 704 is configured to predict and select units for a user in accordance with a user plan and to optimize the user plan based on changes made to the types of the selected units by the user, as described herein. The output module 404 is configured to present the selected units to the user, present an optimized user plan to the user, and to initiate the fulfillment of a user's order, as described herein. Although the unit-type-prediction engine 404 and output module 406 are illustrated as separate components, embodiments are not so limited. Rather, one or more computing components, modules, or systems may be employed to perform the functionality of the unit-type-prediction engine 404 and output module 406.

Memory 402 may also store other programs and data 410, may include operating systems or other information. For example, in some embodiments, the data stored by the user database 112, the item-inventory database 114, the unit database 116, or the item-information database 118, or some combination thereof, may be stored in the memory 402 of the order-fulfillment system 102.

In various embodiments, the network connections 422 include transmitters and receivers (not illustrated) to send and receive data (e.g., optimized user plans, user acceptance or denial of an optimized user plan, etc.) as described herein. I/O interfaces 418 may include one or more data input or output interfaces that can be used to receive information from or display information to an administrator. Other computer-readable media 420 may include other types of stationary or removable computer-readable media, such as removable flash drives, external hard drives, or the like.

The following is a summarization of the original claims as filed.

A method may be summarized as comprising: receiving a user plan for a plurality of units; determining a type of each unit of the plurality of units based on the user plan; selecting the plurality of units for the user in accordance with the determined type of each unit; receiving user input that changes the type of at least one unit of the selected plurality of units; and optimizing the user plan based on the user input.

The method may further comprise: providing the optimized user plan to the user.

The method may further comprise: receiving acceptance of the optimized user plan from the user.

The method may further comprise: receiving a rejection of the optimized user plan from the user; and disregarding the optimized user plan.

The method may optimize the user plan including: determining that the changes exceed a threshold number of changes; and optimizing the user plan based on the user input in response to the changes exceeding the threshold number of changes.

The method may optimize the user plan including: modifying the user plan to include the changed type of the at least one unit.

The method may optimize the user plan including: determining that the user has selected a specific unit a threshold number of times; and modifying the user plan such that the specific unit is to automatically selected in the future for the user.

A computing system may be summarized as comprising: a memory configured to store computer instructions; and a processor system configured to execute the computer instructions to: receive a user plan for a frequency of a plurality of units; and for each frequency interval: determine a type of each unit of the plurality of units based on the user plan; select the plurality of units for the user in accordance with the determined type of each unit; receive user input that changes the type of at least one unit of the selected plurality of units; and optimize the user plan based on the user input.

The processor system may be configured to further execute the computer instructions to: provide the optimized user plan to the user.

The processor system may be configured to further execute the computer instructions to: receive acceptance of the optimized user plan from the user.

The processor system may be configured to further execute the computer instructions to: receive a rejection of the optimized user plan from the user; and disregard the optimized user plan.

The processor system may be configured to optimize the user plan by further executing the computer instructions to: determine that the changes exceed a threshold number of changes; and optimize the user plan based on the user input in response to the changes exceeding the threshold number of changes.

The processor system may be configured to optimize the user plan by further executing the computer instructions to: modify the user plan to include the changed type of the at least one unit.

The processor system may be configured to optimize the user plan by further executing the computer instructions to: determine that the user has selected a specific unit a threshold number of times; and modify the user plan such that the specific unit is to automatically selected in the future for the user.

A non-transitory computer-readable medium may be summarized as storing computer instructions that, when executed by at least one processor, cause the at least one processor to perform actions, the actions comprising: receiving a user plan to provide a plurality of units to a user at selected intervals; and for each selected interval: determining a type of each unit of the plurality of units based on the user plan; selecting the plurality of units for the user in accordance with the determined type of each unit; providing the plurality of units to the user; receiving user input that changes the type of at least one unit of the selected plurality of units; and optimizing the user plan based on the user input.

The computer instructions, when executed by the at least one processor, may cause the at least one processor to perform further actions, the further comprising: providing the optimized user plan to the user.

The computer instructions, when executed by the at least one processor, may cause the at least one processor to perform further actions, the further comprising: receiving acceptance of the optimized user plan from the user.

The computer instructions, when executed by the at least one processor, may cause the at least one processor to perform further actions, the further comprising: receiving a rejection of the optimized user plan from the user; and disregarding the optimized user plan.

The computer instructions, when executed by the at least one processor to optimize the user plan, may cause the at least one processor to perform further actions, the further comprising:
determining that the changes exceed a threshold number of changes; and optimizing the user plan based on the user input in response to the changes exceeding the threshold number of changes.

The computer instructions, when executed by the at least one processor to optimize the user plan, may cause the at least one processor to perform further actions, the further comprising:
modifying the user plan to include the changed type of the at least one unit.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a user plan for a plurality of units;
determining a type of each unit of the plurality of units based on the user plan;
selecting the plurality of units for the user in accordance with the determined type of each unit;
receiving user input that changes the type of at least one unit of the selected plurality of units; and
optimizing the user plan based on the user input.

2. The method of claim 1, further comprising:
providing the optimized user plan to the user.

3. The method of claim 1, further comprising:
receiving acceptance of the optimized user plan from the user.

4. The method of claim 1, further comprising:
receiving a rejection of the optimized user plan from the user; and
disregarding the optimized user plan.

5. The method of claim 1, wherein optimizing the user plan comprises:
determining that the changes exceed a threshold number of changes; and
optimizing the user plan based on the user input in response to the changes exceeding the threshold number of changes.

6. The method of claim 1, wherein optimizing the user plan comprises:
modifying the user plan to include the changed type of the at least one unit.

7. The method of claim 1, wherein optimizing the user plan comprises:
determining that the user has selected a specific unit a threshold number of times; and
modifying the user plan such that the specific unit is to automatically selected in the future for the user.

8. A computing system, comprising:
a memory configured to store computer instructions; and
a processor system configured to execute the computer instructions to:
receive a user plan for a frequency of a plurality of units; and
for each frequency interval:
determine a type of each unit of the plurality of units based on the user plan;
select the plurality of units for the user in accordance with the determined type of each unit;
receive user input that changes the type of at least one unit of the selected plurality of units; and
optimize the user plan based on the user input.

9. The computing system of claim 8, wherein the processor system is configured to further execute the computer instructions to:
provide the optimized user plan to the user.

10. The computing system of claim 8, wherein the processor system is configured to further execute the computer instructions to:
receive acceptance of the optimized user plan from the user.

11. The computing system of claim 8, wherein the processor system is configured to further execute the computer instructions to:
receive a rejection of the optimized user plan from the user; and
disregard the optimized user plan.

12. The computing system of claim 8, wherein the processor system is configured to optimize the user plan by further executing the computer instructions to:
determine that the changes exceed a threshold number of changes; and
optimize the user plan based on the user input in response to the changes exceeding the threshold number of changes.

13. The computing system of claim 8, wherein the processor system is configured to optimize the user plan by further executing the computer instructions to:
modify the user plan to include the changed type of the at least one unit.

14. The computing system of claim 8, wherein the processor system is configured to optimize the user plan by further executing the computer instructions to:
determine that the user has selected a specific unit a threshold number of times; and
modify the user plan such that the specific unit is to automatically selected in the future for the user.

15. A non-transitory computer-readable medium storing computer instructions that, when executed by at least one processor, cause the at least one processor to perform actions, the actions comprising:
receiving a user plan to provide a plurality of units to a user at selected intervals; and
for each selected interval:
determining a type of each unit of the plurality of units based on the user plan;
selecting the plurality of units for the user in accordance with the determined type of each unit;
providing the plurality of units to the user;
receiving user input that changes the type of at least one unit of the selected plurality of units; and
optimizing the user plan based on the user input.

16. The non-transitory computer-readable medium of claim 15, wherein the computer instructions, when executed by the at least one processor, cause the at least one processor to perform further actions, the further comprising:
providing the optimized user plan to the user.

17. The non-transitory computer-readable medium of claim 15, wherein the computer instructions, when executed by the at least one processor, cause the at least one processor to perform further actions, the further comprising:
receiving acceptance of the optimized user plan from the user.

18. The non-transitory computer-readable medium of claim 15, wherein the computer instructions, when executed by the at least one processor, cause the at least one processor to perform further actions, the further comprising:
receiving a rejection of the optimized user plan from the user; and
disregarding the optimized user plan.

19. The non-transitory computer-readable medium of claim 15, wherein optimizing the user plan comprises:
determining that the changes exceed a threshold number of changes; and
optimizing the user plan based on the user input in response to the changes exceeding the threshold number of changes.

20. The non-transitory computer-readable medium of claim 15, wherein optimizing the user plan comprises:
modifying the user plan to include the changed type of the at least one unit.
